(19) United States
(12) Patent Application Publication
(10) Pub. No.: US 2025/0127315 A1
(43) Pub. Date: Apr. 24, 2025

(54) Glow In The Dark Blanket And Flat Screen Printing Method

(71) Applicant: Carrie Knapp, Howell, MI (US)

(72) Inventor: Carrie Knapp, Howell, MI (US)

(21) Appl. No.: 18/383,406

(22) Filed: Oct. 24, 2023

Related U.S. Application Data
(60) Provisional application No. 63/400,694, filed on Aug. 24, 2022.

(51) Int. Cl. A47G 9/02; A47G 9/00; B41F 15/08; B41F 17/00; C25D 3/04; C25D 3/38; C25D 5/00; C25D 5/12; C25D 5/50; C25D 7/00

(52) U.S. Cl. CPC A47G 9/0223; C25D 3/04; C25D 3/38; C25D 5/12; C25D 5/50; C25D 5/627; C25D 7/00; A47G 2009/005; B41F 15/0859; B41F 17/003; B41P 2215/50

(57) ABSTRACT

A method of manufacturing a Glow in the Dark Blanket on Premium GSM is glow-in-the-dark blanket that combines premium quality, exceptional durability, vibrant visual representation, and safety features. With a high GSM of 360 and large, colorful glow-in-the-dark images, this blanket delivers a captivating and enchanting experience for users. It addresses the limitations of conventional glow-in-the-dark blankets, ensuring longevity, visual appeal, and flame retardancy.

### CROSS-REFERENCE TO RELATED APPLICATIONS

This application relates to U.S. 63/400,694 filed on Aug. 24, 2022 and claims it in its entirety.

### BACKGROUND OF THE INVENTION

A flat screen-printing process is presently disclosed. According to some embodiments, FIGS. 1-3 depict prior art which is the circular printing screen method. FIGS. 4-7 depict the flat screen-printing process.

The differences between flat screen printing and circular screen printing consist of different plate making materials. Flat screen printing tends to be made of nylon materials and the plate frame is generally rectangular while the circular screen-printing plate is a metal screen that is made of nickel while the screen is round.

Glow-in-the-dark textiles, such as blankets and fabrics, have long been favored for their ability to emit a soothing and captivating glow in low-light conditions. Traditional glow-in-the-dark blankets, however, often suffer from limitations that compromise their appeal, longevity, and safety.

Conventional glow-in-the-dark blankets typically have a low GSM (Grams per Square Meter) rating, which results in thin and less durable fabrics. Moreover, these blankets usually feature simple, monochromatic glow patterns or cut-out shapes with limited visual appeal. Safety concerns also persist, as many of these blankets lack flame retardant properties.

The present invention aims to revolutionize the field of glow-in-the-dark blankets by addressing these drawbacks and introducing innovative features that elevate the user experience. By utilizing a premium GSM of 360, incorporating large, colorful, and highly detailed glow-in-the-dark images, and ensuring flame retardancy, the invention provides a unique and improved bedding solution.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The “Glow in the Dark Blanket on Premium GSM” is a groundbreaking invention that redefines the concept of glow-in-the-dark textiles. This innovative blanket introduces a host of features to enhance its quality, durability, visual appeal, and safety.

Central to this invention is the use of a premium GSM rating of 360, setting it apart from traditional glow-in-the-dark blankets. This elevated GSM ensures exceptional durability, thickness, and longevity, making the “Glow in the Dark Blanket on Premium GSM” a reliable and long-lasting bedding choice.

Unlike conventional glow blankets with simple and monotonous designs, this invention offers vibrant, colorful, and intricately detailed glow-in-the-dark images. Each design incorporates more than ten colors, creating captivating visual displays when exposed to darkness.

Safety is a paramount concern, and this invention addresses it by incorporating flame retardant properties into its design. This critical feature reduces the safety risks associated with traditional blankets.

The effectiveness of the “Glow in the Dark Blanket on Premium GSM” is attributed to the utilization of the strongest available glow-in-the-dark material in each design. This material possesses exceptional photoluminescent properties, resulting in a radiant and long-lasting glow.

Additionally, user comfort is prioritized, with the combination of premium GSM and soft, high-quality materials ensuring a luxurious and cozy experience. The blanket offers warmth, plushness, and captivating glow-in-the-dark visuals, making it suitable for users of all ages.

The invention finds versatile applications in various settings, including bedrooms, nurseries, and themed décor for events. Its visual appeal, durability, and safety features make it an ideal choice for individuals seeking an elevated and enchanting bedding experience.

While the shapes of the screen plates are different between the two methods, the size of the circular screen is fixed. The circular screen is generally 64 cm in radius. The size of the flat screen is generally not limited as long as the length of the machine can meet the requirements of the job.

While Circular screen printing is suitable for mass production due to it being a continuous process as the fabric is conveyed through a circular screen tube with a wide rubber belt, it is not suited for small batch printing like flat screen printing.

The principle of flat screen printing is the same as that of manual screen printing, but the process is automatic, so the speed is faster. The printed fabric is conveyed to the screen through a wide rubber belt, rather than (like manual screen printing) being placed on a long table. Like manual screen printing, automatic screen printing is also a batch process.

Cotton fabrics and patterns with multiple printing rights has requirements on details and outlines that are relatively high. Flat screen printing can meet these kinds of demands.

### BRIEF DESCRIPTION OF DRAWINGS

FIG. 1 shows a perspective view of the circular printing screen method which is prior art.

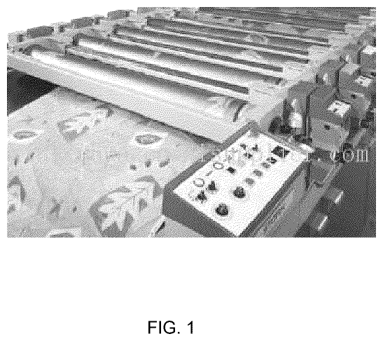

FIG. 2 shows a perspective view of the circular printing screen method which is prior art.

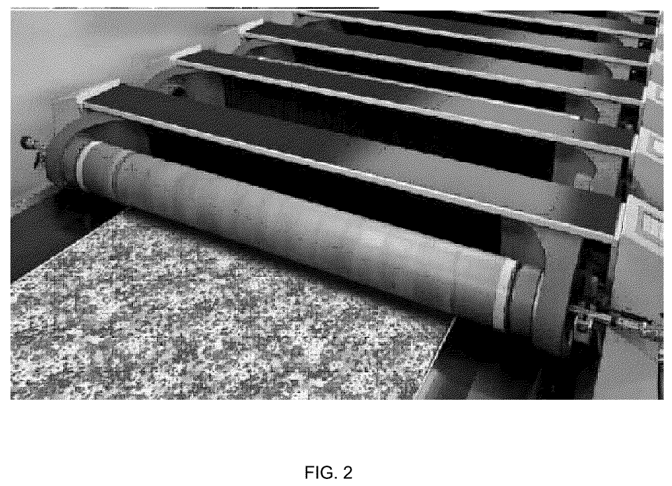

FIG. 3 shows a perspective view of the circular printing screen method which is prior art.

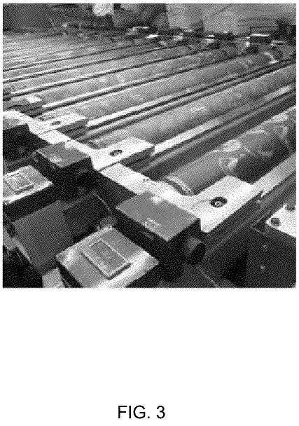

FIG. 4 shows a perspective view of the flat screen-printing process.

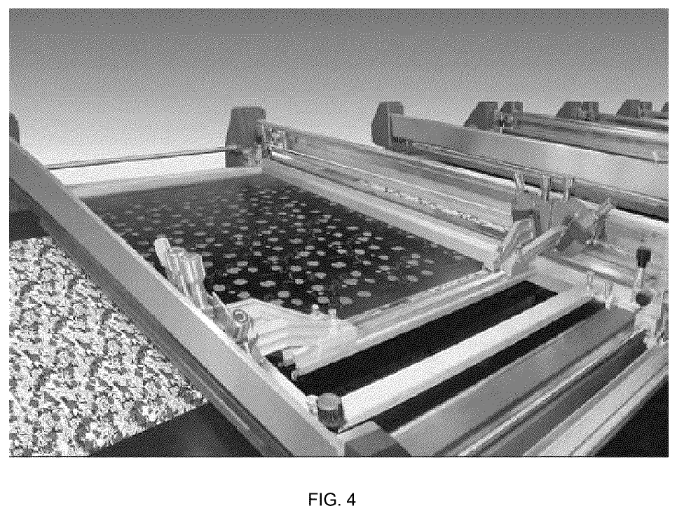

FIG. 5 shows a perspective view of the flat screen-printing process.

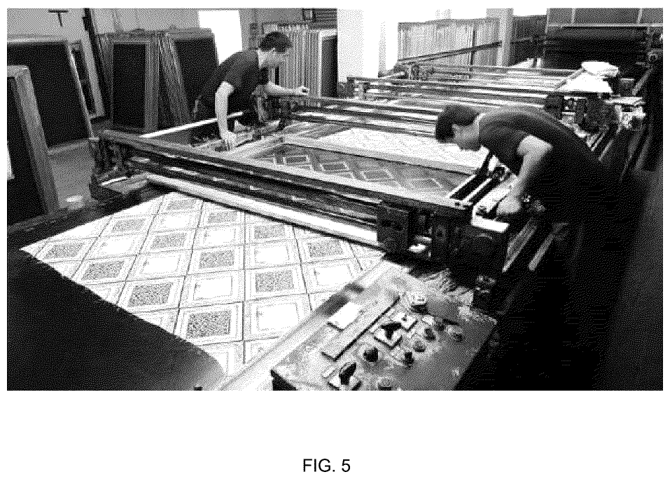

FIG. 6 shows a perspective view of the flat screen-printing process.

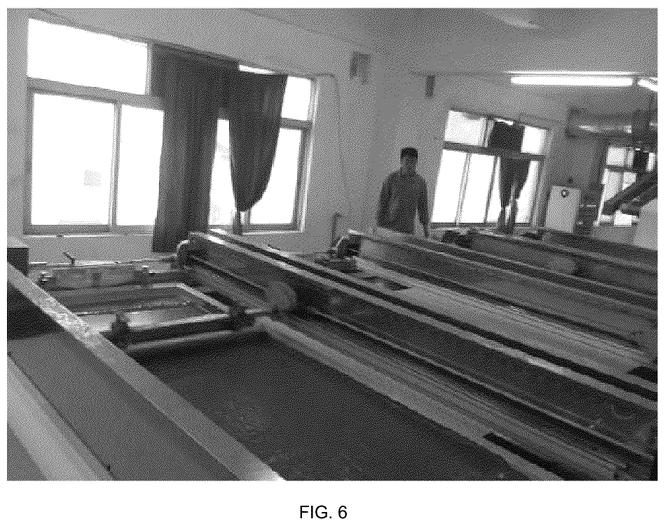

FIG. 7 shows a perspective view of the flat screen-printing process.

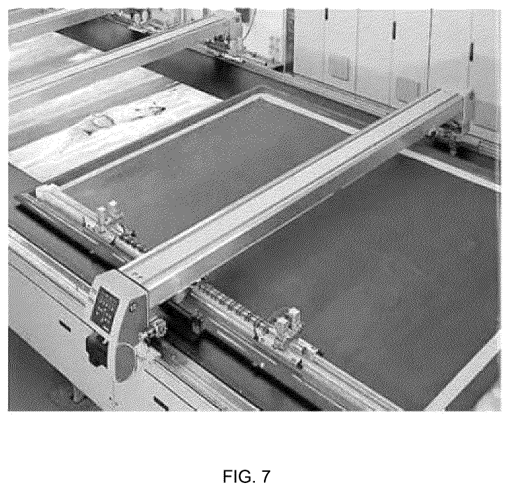

### DETAILED DESCRIPTION OF THE INVENTION

The overall process involves using the following:
Round tube core mold;
Copper plating;
Polishing;
Rolling point;
Polishing;
Chromium Plating;
Embedded insulator;
Heating;
Hardening;
Polishing;
Cleaning;
Demolding; and
Nickel mesh forming.

Copper plating can make the core mold meet the requirements of the circumference of the circular mesh, and because the copper metal is soft and easy to roll. The rolling point is to roll out the round mesh specification on the copper-plated core die. Chromium plating is easy to demold after the nickel mesh is formed due to the poor bonding force between chromium and nickel.

The embedded insulator is an insulator embedded in the mesh part, so that no current is passed during electroplating: the non-embedded part is plated with nickel metal, and a nickel mesh with holes can be formed. Generally, the epoxy resin 604 and the epoxy resin catalyst 650 are mixed in equal amounts. After coating, the insulator was cured by baking at 175° C. for 7 minutes.

Nickel plating is carried out in nickel sulfate and nickel oxide plating solutions. The thickness of nickel mesh is generally 0.10-0.12 mm. After the requirements are met, the nickel mesh is de-molded by mechanical extrusion.

The rotary screen-printing machine is usually composed of four parts: feeding device, printing head, drying device and cloth dropping device. At present, there are eight color, twelve color, sixteen color and twenty-four color circular screen printing machines. There are mainly two types of printing machine: 640 mm and 904 mm.

The rotary screen-printing machine with 640 mm flower back is in the majority. The circular screen-printing machine has the advantages of simple operation, low labor intensity and high output. It is suitable for printing of various fabrics, and it is also suitable for printing of multi varieties and small batches of fabrics.

It is important to understand the concept of circular screen printing. Circular screen printing is a printing method that uses a scraper or a magnetic rod to print the color paste in the circular screen onto the fabric under the pressure. Circular screen printing differs from other screen-printing methods in several important aspects. Circular screen printing, like roller printing, is a continuous process. The printed fabric is conveyed to the bottom of the circular screen flowerpot through a wide rubber belt. In screen printing, the production speed of circular screen printing is the fastest available with production reaching more than 3500 yards per hour. It uses seamless perforated metal mesh or plastic mesh. The maximum circle is greater than 40 inches, so the maximum return size is also greater than 40 inches. More than 20 sets of circular screen-printing machines have also been produced, and this printing method is gradually replacing roller printing. That is to say, the main advantage of circular screen printing is fast speed, but the disadvantage is that the return can only be within the circumference of the screen.

There are three types of flat screen printing: manual plate type, semi-automatic flat plate and full-automatic flat plate. Although the output of flat screen printing is low, it is convenient to make plates, has a large length of flower back, and has many colors. It can print fine patterns without color transmission, has a large amount of printing pulp, and has a three-dimensional feeling. It is suitable for printing of silk, cotton, chemical fiber and other woven fabrics and knitted fabrics, and is more suitable for printing of high-end fabrics in small batches and varieties. That is to say, the flower back size of flat screen printing can be determined according to the actual size. Theoretically, the current printing size (reasonable) can be realized on the flat screen, such as photo printing and process printing in ways that is not possible with the round screen printing. The fineness and flower back size with circular printing cannot be improved whereas flat screen excels in this regard.

The improved process has allowed for the widening of glow lines with regard to glow-in-the-dark blankets and has allowed for the use of stronger glow material. This glow material is now 30% stronger than what has been previously used. Flat printing also allows for a more detailed design and image which improves the quality of the image over circular printing.

The “Glow in the Dark Blanket on Premium GSM” represents a pioneering advancement in the field of glow-in-the-dark textiles. This section provides a comprehensive and detailed description of the various aspects and features of the invention.

At the heart of this invention is the utilization of a premium GSM rating of 360. This elevated GSM rating signifies a substantial departure from the lower GSM typically associated with traditional glow-in-the-dark blankets. The significant enhancement in GSM plays a pivotal role in establishing the durability and longevity of the Glow in the Dark Blanket on Premium GSM.

The premium GSM ensures that the blanket maintains its thickness, quality, and structural integrity even after undergoing multiple washing cycles. Unlike conventional glow-in-the-dark blankets that tend to thin out and lose effectiveness over time, the “Glow in the Dark Blanket on Premium GSM” exhibits remarkable resilience, making it a reliable and enduring addition to any bedding collection.

One of the standout features of this invention is its ability to offer captivating, colorful, and highly detailed glow-in-the-dark images. Traditional glow blankets often feature rudimentary patterns, simple cut-out shapes, or monochromatic glow designs. In stark contrast, the Glow in the Dark Blanket on Premium GSM embraces a revolutionary approach to visual aesthetics.

Each design featured on this blanket boasts an extensive palette of more than ten vibrant colors. This rich and diverse color scheme results in intricately detailed images that come to life when exposed to darkness. Users can experience an unparalleled visual spectacle as the blanket's colorful and radiant images illuminate their surroundings, transforming any space into a captivating and enchanting environment.

Safety is a paramount concern when introducing textiles into homes and around children. The Glow in the Dark Blanket on Premium GSM ensures peace of mind by incorporating flame retardant properties into its design. This critical safety feature significantly reduces the risk associated with the use of the blanket, making it a safe and responsible choice for consumers.

The effectiveness of the Glow in the Dark Blanket on Premium GSM is attributed to the utilization of the strongest available glow-in-the-dark material in each design. This photoluminescent material possesses exceptional light-absorbing and energy-storing properties, resulting in a radiant and long-lasting glow in darkened environments. The glow-in-the-dark material is strategically integrated into the blanket's designs to ensure optimal luminance and visual impact.

The Glow in the Dark Blanket on Premium GSM places user comfort and satisfaction at its forefront. The combination of a premium GSM and soft, high-quality materials ensures that the blanket is not only durable but also luxuriously soft to the touch. Users can enjoy the comforting warmth and plushness of the blanket while experiencing the magic of its captivating glow-in-the-dark images.

The Glow in the Dark Blanket on Premium GSM is versatile and adaptable, finding applications in various settings. It serves as an attractive addition to bedrooms, children's nurseries, and themed décor for parties and events. Its visually appealing glow-in-the-dark images make it a favored choice among individuals of all ages.

The Glow in the Dark Blanket on Premium GSM represents a groundbreaking advancement in the field of glow-in-the-dark textiles. Its premium GSM, captivating glow-in-the-dark images, flame retardant properties, and user-centric design converge to create a product that stands out in terms of quality, durability, and visual appeal. This invention redefines the concept of glow-in-the-dark blankets, offering consumers an elevated and enchanting bedding experience.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A glow-in-the-dark blanket, comprising:
A textile body with a GSM rating of 360.
A plurality of glow-in-the-dark images, each featuring more than ten colors, prominently displayed on the textile body.
Flame retardant properties integrated into the textile body to enhance safety.

2. The glow-in-the-dark blanket of claim 1, wherein the GSM rating of 360 ensures exceptional durability and longevity, maintaining the thickness and structural integrity of the textile body even after multiple washing cycles.

3. The glow-in-the-dark blanket of claim 1 or 2, wherein the plurality of glow-in-the-dark images includes diverse and intricately detailed designs that emit captivating, vibrant, and colorful glows when exposed to darkness.

4. The glow-in-the-dark blanket of any one of claims 1 to 3, wherein the flame-retardant properties reduce the risk of fire-related incidents, making the blanket suitable for use in various settings, including bedrooms and children's nurseries.

5. The glow-in-the-dark blanket of any one of claims 1 to 4, further comprising a soft, high-quality material, ensuring a luxurious and comfortable user experience while offering exceptional warmth and plushness.

6. The glow-in-the-dark blanket of any one of claims 1 to 5, wherein the glow-in-the-dark material integrated into the plurality of glow-in-the-dark images possesses exceptional photoluminescent properties, resulting in a radiant and long-lasting glow.

7. The glow-in-the-dark blanket of any one of claims 1 to 6, suitable for versatile applications in bedrooms, children's nurseries, and themed décor for events, providing users of all ages with an enchanting and captivating bedding experience.

8. A method of manufacturing a Glow in the Dark Blanket on Premium GSM comprising of:
Round tube core mold;
Copper plating;
Polishing;
Rolling point;
Polishing;
Chromium Plating;
Embedded insulator;
Heating;
Hardening;
Polishing;
Cleaning;
Demolding; and
Nickel mesh forming.

9. The method of manufacturing a Glow in the Dark Blanket on Premium GSM as in claim 8, wherein the copper plating can make the core mold meet the requirements of the circumference of the circular mesh.

10. The method of manufacturing a Glow in the Dark Blanket on Premium GSM as in claim 8, wherein the embedded insulator is in the mesh, so that no current is passed during electroplating.

11. The method of manufacturing a Glow in the Dark Blanket on Premium GSM as in claim 8, wherein the epoxy resin 604 and the epoxy resin catalyst 650 are mixed in equal amounts and after coating, the insulator is cured by baking at 175° C. for 7 minutes.

12. The method of manufacturing a Glow in the Dark Blanket on Premium GSM as in claim 8, wherein the nickel plating is carried out in nickel sulfate and nickel oxide plating solutions. The thickness of nickel mesh is generally 0.10-0.12 mm. After the requirements are met, the nickel mesh is demolded by mechanical extrusion.
